(19) United States
(12) Patent Application Publication
(10) Pub. No.: US 2002/0190176 A1
(43) Pub. Date: Dec. 19, 2002

(54) Universal mobile phone hand free holder

(76) Inventor: Richard Louh, Lung-Tan Hsiang (TW)

Correspondence Address: JACOBSON HOLMAN PLLC, 400 SEVENTH STREET N.W., SUITE 600, WASHINGTON, DC, 20004, US

(21) Appl. No.: 09/880,789

(22) Filed: Jun. 15, 2001

(51) Int. Cl. A47G 1/10; H04M 1/00

(52) U.S. Cl. 248/316.4; 248/316.7; 248/316.1; 379/455

(57) ABSTRACT

A universal mobile phone hand free holder has a base with two opposite clamping arms movable with respect to each other, a reel located in the base for retracting wires of the ear set, an audio clip mounted on a side of the base to cover the speaker of the mobile phone so as to transfer the audio signal from the mobile phone speaker to the speaker of the base and a hook for hanging the ear set. A channel display is provided on the base such that the user is able to select a suitable channel for the mobile phone. Accordingly, the holder is suitable for any size and type of mobile phone, and any mobile phone system.

### BACKGROUND OF THE INVENTION

1. Field of the Invention

The present invention relates to a mobile phone hand free holder, and more particularly to a mobile phone holder with a universal joint with which the mobile phone supported by the holder is able to pivot to any desired direction to facilitate the access for the user.

2. Description of Related Art

A conventional mobile phone holder, as shown in FIG. 1, has a base (1a) and an electrical suspension rod (2a) pivotally connected to the base (1a) and electrically connected to a cigarette lighter (not shown) for provide electricity to the base (1a). The base (1a) has a socket (3) electrically connected with the suspension rod (2a) for receiving therein a mobile phone. The socket (3) has a terminal (3a) formed on a bottom of the socket (3) so that the mobile phone has power supply from the terminal (3a) and is able to be recharged simultaneously when the mobile phone is received in the socket (3). Furthermore, a side face in front of the base (1a) is provided with a microphone (4a) and a speaker (not shown) in the rear of the base (1a). With such an arrangement, a user is able to use the mobile phone received in the socket (3) and talk to the caller by means of the microphone (4a). The phone holder of thin kind is able to pivot in relation to the end of the electrical suspension rod (2a) and the user is able to adjust the angle of the phone holder as required.

However, the phone holder can only pivot with respect to the electrical suspension rod (2a), that is, the phone holder can not be adjusted transversely to fulfill the user's need, not to mention the electrical outlet for the electrical suspension rod (2a) normally is located under the front panel of the car, which hinders the access of the user to the gear shift and thus affects the driving safety greatly.

Further, the conventional phone holder can only adopt to one specific size, type and system of mobile phone. That is, when the user changes the size or type of the mobile phone or travels to a country with different mobile phone system, the mobile phone holder will have to be abandoned.

To overcome the shortcomings, the present invention intends to provide an improved mobile phone holder to mitigate or obviate the aforementioned problems.

### SUMMARY OF THE INVENTION

The primary objective of the invention is to provide a mobile phone hand free holder enabling the user to clamp mobile phones of different dimensions. The mobile phone holder has a pair of clamping arms oppositely formed on the base and being resiliently movable relative to the base, such that the clamping arms are able to clamp mobile phones of different sizes or types or using a different mobile system, without the necessity of fitting into a socket, thereby allowing the mobile phone use in another country.

Another objective of the invention is to have a reel to locate the wire of the ear set so that the user is able to organize the wire easily.

Still another objective of the invention is to have a mode switching system to enable the user to switch from the ear set of the mobile phone to the speaker of the car.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a conventional mobile phone holder;

FIG. 2 is a perspective view of a mobile phone holder constructed in accordance with the present invention;

FIG. 3 is a front side view of the mobile phone holder in FIG. 2;

FIG. 4 is a right side view of the mobile phone holder in FIG. 2;

FIG. 5 is a cross sectional view of the clip of the present invention;

FIG. 6 is a perspective view showing the engagement between the clip and the mobile phone holder in FIG. 2;

FIG. 7 is a rear side view of the mobile phone holder in FIG. 2;

FIGS. 8 and 9 are cross sectional views showing the clamping arms in operation;

FIG. 10 is a front side view showing the reel is received in the mobile phone holder in FIG. 2;

FIG. 11 is a front side view showing the mobile phone holder of the present invention has a built-in channel; and

FIG. 12 is a front side view showing the mobile phone holder of the present invention without a built-in channel.

### DETAILED DESCRIPTION OF PREFERRED EMBODIMENT

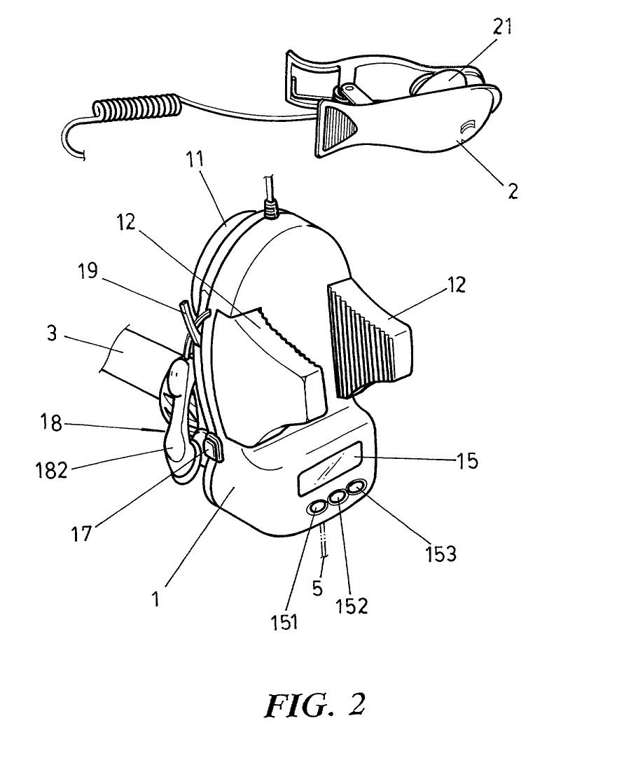

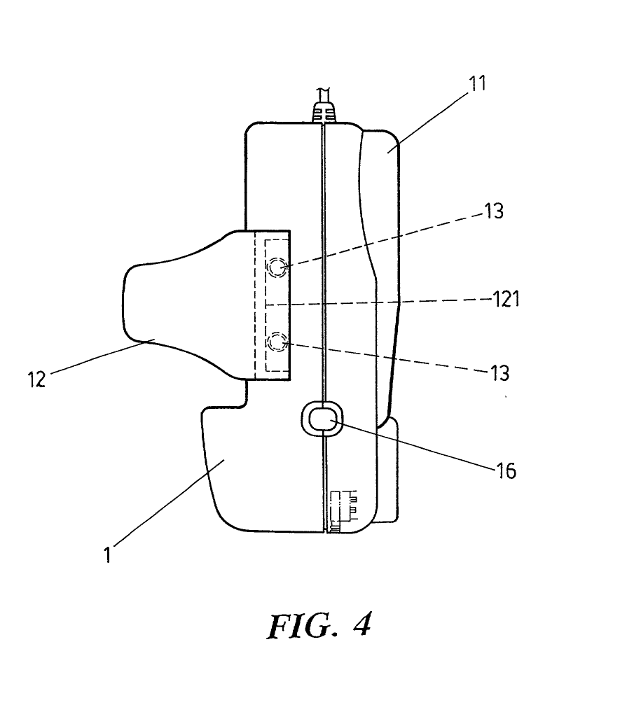

With reference to FIGS. 2, 3 and 4, a universal mobile phone hand free holder in accordance with the present invention has a base (1) for detachably receiving a mobile phone, a clip (2) and an electrical plug (3).

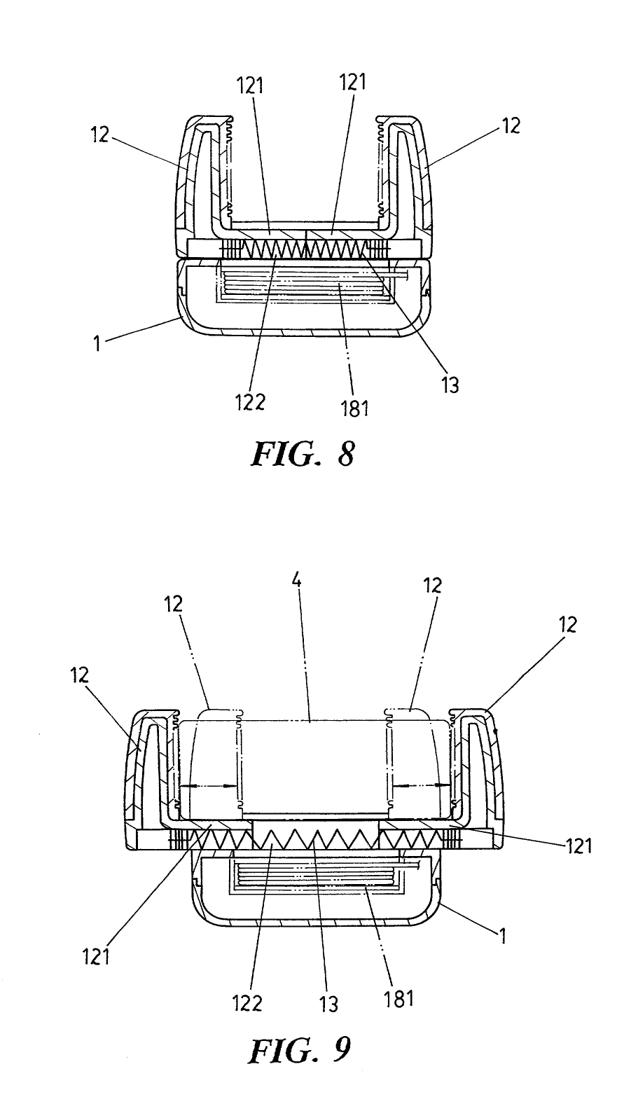

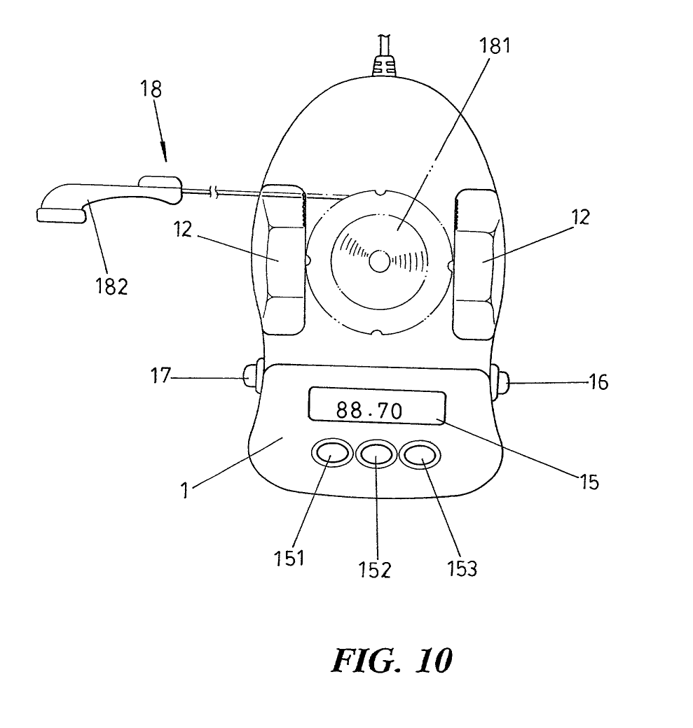

The base (1) is adapted to hold a mobile phone therein and has a pair of clamping arms (12) each formed on opposite sides of the base (1). The two clamping arms (12) are connected with each other by a pair of springs (13). Each of the clamping arms (12) has an extension (121) extending toward the base (1) and having an elongated recess (122) defined in a bottom side of the extension (121). The base (1) has two pairs of positioning studs (14) each pair corresponding to two opposite elongated recesses (122). Each positioning stud (14) is received in a corresponding one of the elongated recesses (122), such that the lateral movement of the two clamping arms (12) are guided by the positioning studs (14). That is, the two clamping arms (12) can only move toward to or away from each other. There is no longitudinal movement of the two clamping arms (12) relative to the base (1). Therefore, with reference to FIGS. 8 and 9, when mobile phones of different dimensions are to be received in the base (1), because of the springs (13), the two clamping arms (12) are able to extend to a suitable position to provide a sufficient force to the mobile phone.

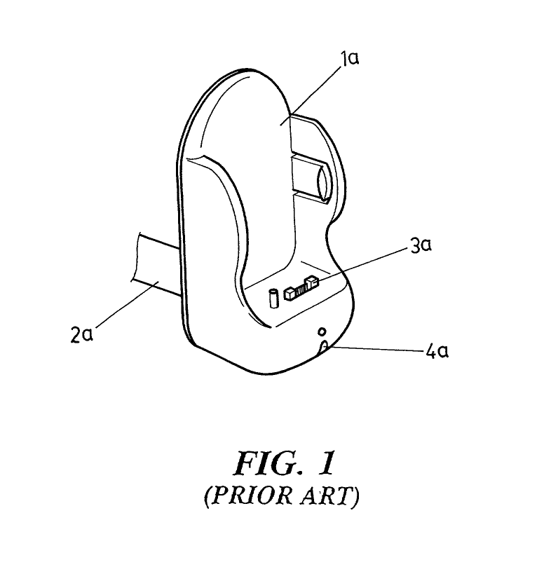

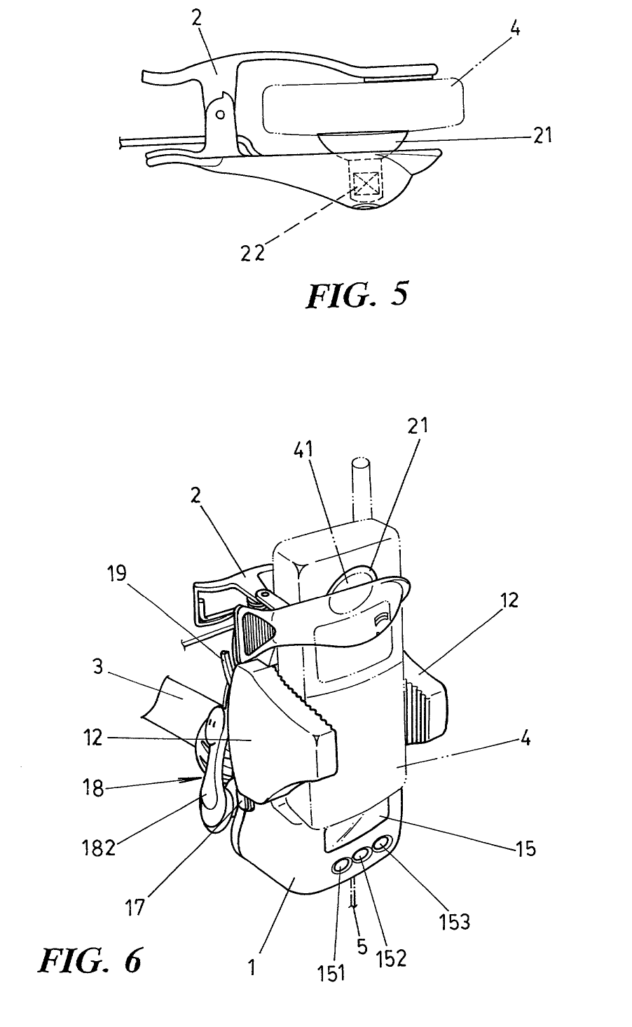

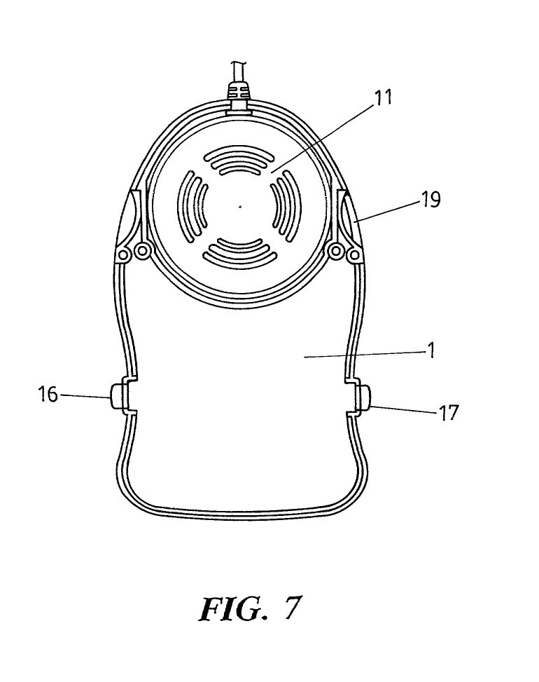

With reference to FIGS. 1, 5 and 6, an audio clip is provided to the base (1) and has a bowl (21) suitable to cover the speaker (41) of the mobile phone (4) and a microphone (22) securely mounted inside the bowl (21) and electrically connected with the circuitry inside the base (1), such that an audio signal picked up by the microphone (22) is able to be selectively output by the speaker (11) of the base (1) or by the speaker of the car. Furthermore, with reference to FIG. 7, it is to be noted from the preferred embodiment of the present invention that the speaker (11) of the base (1) is mounted on a rear top side of the base (1).

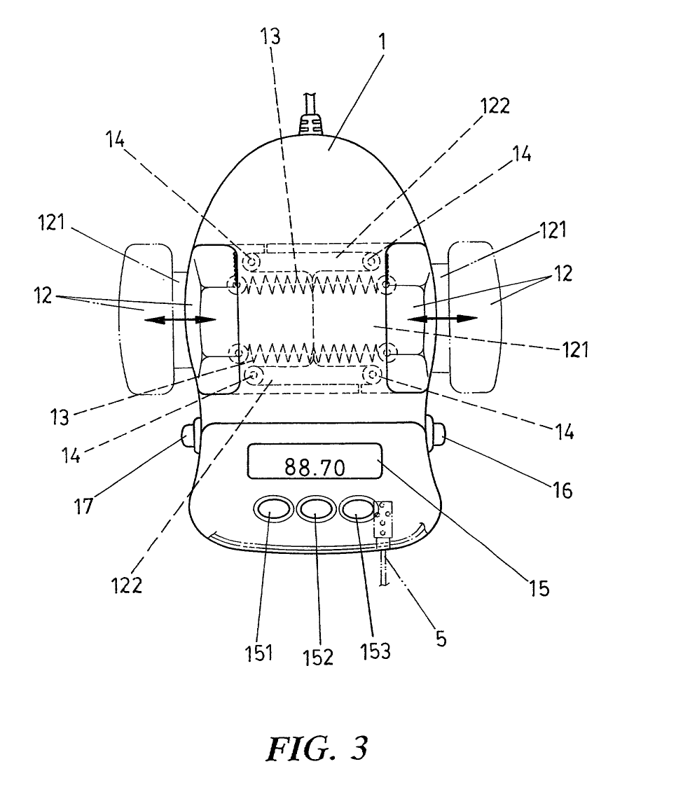

With reference to FIG. 3, a LED channel display (15) is provided on the base (1) and has a channel forward key (151), a channel rearward key (152) and a set key (153) so that the user is able to use the channel forward, rearward keys (151, 152) to search the appropriate channel for the mobile phone. Still, a socket (154) is defined in the base (1) for a short wave antenna (5) to plug in to increase the receiving capacity so as to increase the signal strength.

A first selecting switch (16) is provided on a side of the base (1), which enables the user to freely select the output route of the audio signal, from the speaker (11) of the base (1) or from the speaker of the car. A second selecting switch (17) is mounted on a side of the base (1) opposite to the first selecting switch (16), which enables the user to switch from an ear set (18) (as shown in FIG. 6) or from the speaker (11).

The base (1) further has a reel (181) mounted inside the base (1) for receiving the wire of the ear set (18). When the ear set (18) is in use, the user only needs to pull out the wire from the reel (181) to a suitable length, then the ratchet mechanism inside the reel (181) is able to secure the length of the wire. When the ear set (18) is not in use, the user just needs to slightly pull the wire again to release to limitation from the ratchet mechanism of the reel (181), the resilience force from the spring inside the reel (181) is able to automatically retract the wire to the reel (181). After the wire of the ear set (18) is received in the reel (181), the head set (182) is able to be held by a hook (19) formed on an outer periphery of the base (1), as shown in FIG. 2.

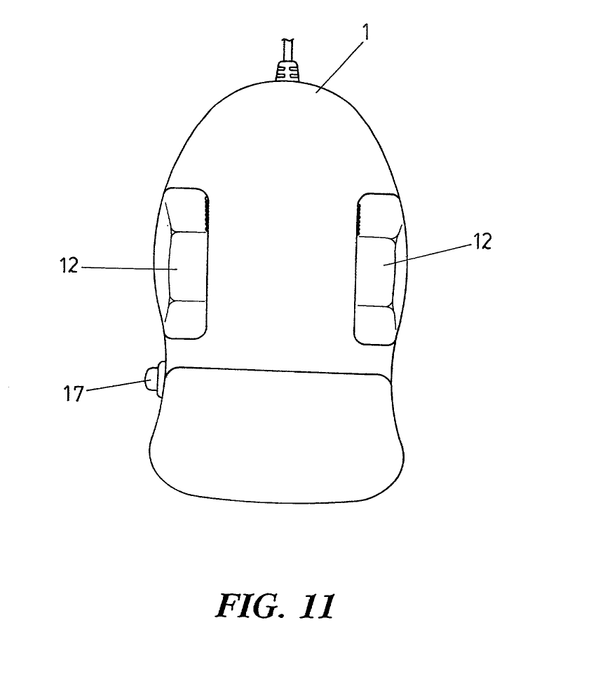

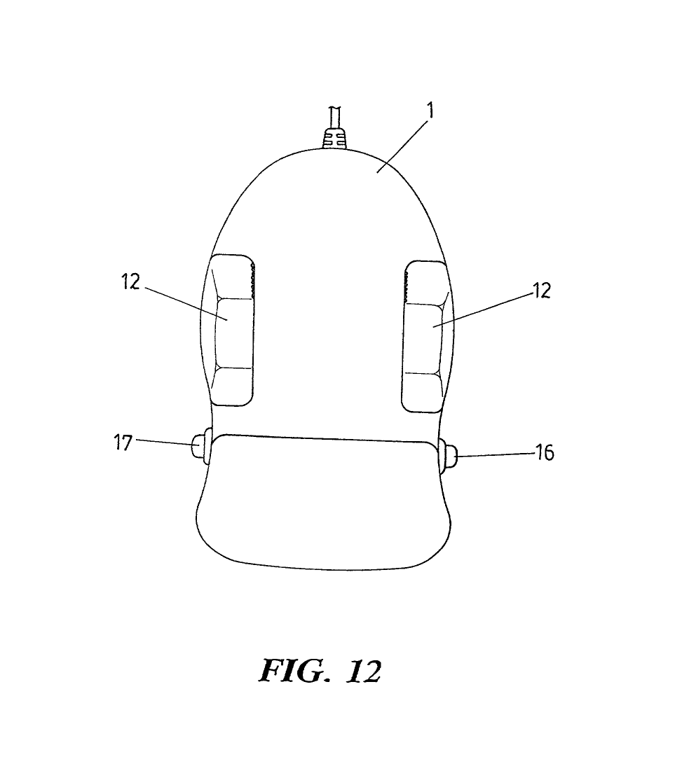

With reference to FIG. 11 and FIG. 12, a built-in channel is mounted inside the car so that there is no LED channel display (15) as shown in FIG. 3. Furthermore, the short wave antenna (5) as shown in FIG. 3 is also optional in that the user is able to decide whether the antenna (5) is required to enhance the signal strength.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A universal mobile phone hand free holder comprising:
a base having a pair of clamping arms each adapted to clamp a mobile phone and movable relative to each other, the clamping arms being mounted on opposite sides of the base;
an audio clip formed on the base for transmitting a voice signal from the mobile phone to a circuitry in the base;
a channel display provided on the base and having a channel forward key, a channel rearward key, a set key so that the user is able to use the channel forward, rearward keys to search the appropriate channel for the mobile phone and a socket defined in the base such that a short wave antenna is able to be plugged in the socket to increase the receiving capacity; and
a first selecting switch provided on a side of the base enabling to freely select the output route of the audio signal, from a speaker of the base or from a speaker of the car.

2. The mobile phone holder as claimed in claim 1, wherein the two clamping arms each has an extension extending toward the base and having an elongated recess defined in a bottom side of the extension, and
wherein the base has positioning studs each corresponding to one of two opposite elongated recesses so that movement of the two clamping arms is guided by the positioning studs.

3. The mobile phone holder as claimed in claim 1, wherein the audio clip has a bowl adapted to cover the speaker of the mobile phone and a microphone securely mounted inside the bowl and electrically connected with the circuitry inside the base such that an audio signal picked by the microphone is able to be selectively output by the speaker of the base or by the speaker of the car.

4. The mobile phone holder as claimed in claim 1, wherein the base further has a reel mounted inside the base for receiving a wire of an ear set, wherein the reel has a ratchet mechanism so that the user only needs to pull out the wire from the reel to a suitable length, then the ratchet mechanism inside the reel is able to secure the length of the wire and when the ear set is not in use, the user just needs to slightly pull the wire again to release to limitation from the ratchet mechanism of the reel, the resilience force from the spring inside the reel is able to automatically retract the wire to the reel.

5. The mobile phone holder as claimed in claim 1, wherein the base further has a hook formed on an outer periphery of the base so as to hang an ear set.

6. The mobile phone holder as claimed in claim 1, wherein the base further has a first selecting switch provided on a side of the base, which enables the user to freely select the output route of the audio signal, from a speaker of the base or from a speaker of a car.

7. The mobile phone holder as claimed in claim 1, wherein the base further has a second selecting switch mounted on a side of the base opposite to the first selecting switch, which enables the user to switch from an ear set to a speaker of a car.
